(19) United States
(12) Patent Application Publication
(10) Pub. No.: US 2003/0059131 A1
(43) Pub. Date: Mar. 27, 2003

(54) Bag provided with an improved support device and process for formation of same

(75) Inventor: Ralph Drake, Milltown, NJ (US)

Correspondence Address: BROWDY AND NEIMARK, P.L.L.C., 624 NINTH STREET, NW, SUITE 300, WASHINGTON, DC, 20001-5303, US

(73) Assignee: SQUARE BOTTOM, Milltown, NJ

(21) Appl. No.: 10/233,015

(22) Filed: Sep. 3, 2002

(30) Foreign Application Priority Data
Aug. 31, 2001 (IT) MI2001A 001846

(51) Int. Cl. B65D 33/06; B31B 1/86

(52) U.S. Cl. 383/17; 493/226

(57) ABSTRACT

It is disclosed a bag (2) provided with an improved support device (1) defined by at least one tubular element (7) having a bent intermediate portion (7a) and end portions (7b) inserted in the bag (2), the tubular element (7) being of thermofusible plastic material, and the end portions (7b) being connected to the bag (2) by heatsealing. The bag is formed arranging at least one tubular element (7) of thermofusible plastic material, bending the tubular element (7) to impose a configuration on it which comprises a bent intermediate portion (7a) and end portions (7b) substantially parallel to each other, inserting the end portions into the mouth (3) of a bag (2) and connecting the bag (2) and end portions (7b) to each other by heatsealing.

### FIELD OF THE INVENTION

The invention relates to a bag having an improved support device and to a process for formation of same.

The bag is of the type currently called “Shopping Bag” for example, which is supplied as a carrying bag at several sale points or as the final packaging of different items and products. The bag is provided with said support device, a mouth or opening extending close to the support device, a bottom opposite to the mouth, and main and side walls extending between the mouth and bottom.

### DESCRIPTION OF THE PRIOR ART

It is known that bags of said type are very often of plastic material or an equivalent sheet-like material and are provided with different types of support devices, placed at the mouth or opening of the bags themselves, to offer an appropriate handgrip.

For example support devices directly formed in the bags and integral therewith are conceived which practically consist of openings formed in the side walls of the bags close to the mouth of same.

Said support devices may also consist of extensions of the bags themselves jutting out of the upper edges of the bag. In this case the concerned bags are also called “T-shirt bags”.

These support devices are simple and cheap but they have the drawback of a limited resistance and a very poor aesthetic appearance.

To obviate this drawback at least partly, said openings are shaped in different manners and in some cases made thicker by means of inner reinforcing elements.

Alternatively, support devices having an independent structure are provided which are defined by appropriate handles connected to the upper ends of the bags. By way of example, there are stiff and thin handles of moulded plastic material defining a loop for the hand at the upper part thereof and a rigid band extending at the bag mouth with which it is integral, at the lower part. These handles are strong and aesthetically valuable, but they are expensive both as regards the manufacturing step because an appropriate moulding operation is required, and as regards the application step because accurate procedures are needed. In addition, since they are thin, the bag weight is concentrated on limited points of the hand, thereby creating a feeling of bother and effort.

Also soft handles are used which are defined by a ribbon or a cut-out lamina or foil extending above the bag mouth.

These handles are of agreeable handling but they offer a poor support which is susceptible of easy breaking.

Finally, support devices used in valuable bags are those made of rope or consisting of a lace possibly of plastic material, ensuring high resistance, good aesthetic level and agreeable handgrip.

They however have the drawback that they require an artisan=3 s work for fastening and are therefore expensive: these support devices in fact have their ends fitted into holes formed in the bags through which they pass to be then locked by end knots.

Alternatively or in addition, these support devices require the presence of fastening elements in the form of adhesive strips or tapes applied to the ends of the ropes or laces for final locking.

To be added to these fastening operations are also other operations such as piercing of the bags with holes and measurement of the ropes and laces to avoid creation of handles of different length in one bag, due to wrong positioning of the ropes and inaccurate formation of the knobs.

### SUMMARY OF THE INVENTION

Generally, still to be solved is the technical problem of providing a bag with a support device which is agreeable and resistant while at the same time being simple and cheap.

Under this situation the technical task underlying the invention is to devise a bag which is able to solve said technical problem and to remedy said drawbacks of the known art.

Within the scope of this technical task it is an aim of the invention to devise a bag able to be manufactured by a process adapted to be accomplished in a completely automated manner.

Another aim of the invention is to devise a bag able to be manufactured by a process which is substantially unaffected by possible manufacture inaccuracies and which is suitable to easily and readily adapt itself to different requirements, in particular for application of a support device having varying sizes selected at will, in terms of length and section.

The technical task mentioned and the aims specified are achieved by a bag provided with an improved support device, said bag having a support device, a mouth extending close to said support device, a bottom opposite to said mouth, and main walls and side walls extending between said mouth and bottom, said support device comprising at least one rod element having at least one intermediate portion of a bent configuration and projecting from said mouth and end portions inserted in said bag, said tubular element being of thermofusible plastic material, and said end portions being connected by heatsealing to at least one of said walls.

### BRIEF DESCRIPTION OF THE DRAWINGS

Description of preferred embodiments of the invention is now set out hereinafter, with reference to the accompanying drawings, in which:

FIG. 1 shows a bag taken as a whole which is provided with the support device in accordance with the invention;

FIG. 2 shows how the said bag is manufactured at a work station;

FIG. 2a shows a portion of the support device; and

FIG. 3 is a block diagram showing the process in its different steps.

### DESCRIPTION OF THE PREFERRED EMBODIMENTS

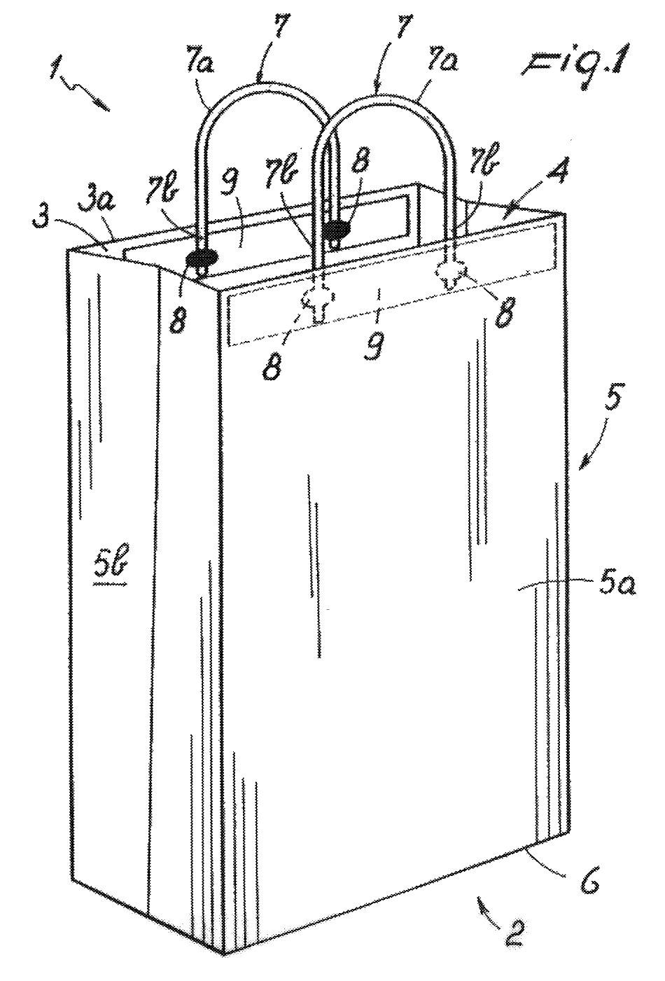

With reference in particular to FIG. 1, an improved support device is generally identified by reference numeral 1.

It is applied to a bag 2 preferably of thermofusible plastic material and of any appropriate shape, provided it has a mouth 3 adapted to define an opening for introduction of various items and articles into a cavity 4. Cavity 4 is defined by walls 5 and a bottom 6 positioned opposite to mouth 3.

At said mouth 3, the walls 5 terminate with an edge or rim 3a. Walls 5 include into main walls 5a and side walls 5b, the latter having a smaller size extension than the main walls 5a.

The support device 1 comprises at least one rod element and preferably two rod elements 7 acting as handles and having at least one intermediate portion 7a which is bent and projects from the edge 3a of mouth 3, and end portions 7b placed at the sides of the intermediate portion 7a and inserted in the cavity 4 of the bag 2 with which they are in engagement.

The rod elements 7 are made of thermofusible plastic material. In the preferred embodiment of the invention, the rod elements 7 are hollow tubular elements, so as to have a light weight also if they have a large section.

Moreover, in the preferred embodiment, the rod elements 7 have a semi-rigid consistency, so that they can be easily bent while by nature they keep a substantially straight shape if they are not submitted to efforts, or they spontaneously keep an arch-shaped configuration, similar to the one shown in FIG. 1 when the end portions 7b are connected to bag 2.

This semi-rigid consistency is obtained choosing a thermofusible plastic material as Polythene or PVC or Polypropylene and also making hollow the rod elements 7.

The end portions 7b of each rod or tubular element 7 are connected by heatsealing, at a region 8 thereof, to a main bag wall 5a.

FIG. 1 shows partly in phantom the rod or tubular elements 7 deformed and squashed at regions 8, by effect of heatsealing operations.

At mouth 3 and in particular at regions 8, bags 2 can possibly have reinforcing and stiffening strips or bars 9. These strips 9 are made of thermofusible plastic material for example, and are applied either by heatsealing to a bag 2 of plastic material or by gluing or stapling to a bag 2 of various sheet material, optionally also of paper.

In the last-mentioned case strips 9 act as connections between the tubular elements 7 and bag 2, so as to enable application of the tubular elements 7 by localised heatsealing on paper bags 2 too.

Bag 2 may also be stiffened at its mouth 3 by a turned-back band thereof or other element and it may be provided with means such as groove-and-rib joints, forked sticks, removable adhesive tape fasteners or hook-loop fastening patches such as Velcro, which are adapted to enable a substantially stable closure of mouth 3, in which the different sections of edge 3a are in close contact with each other.

Use of a bag 2 provided with the above described support device 1 is easy and advantageous from different points of view.

In fact the handles made up of the rod elements 7—which are tubular and semi-rigid—are comfortable for the hand even in the case of relatively heavy loads, since they easily adapt themselves to the hand shape and do not have points or corners of greater stresses.

The rod elements 7 are of agreeable appearance because they naturally keep a convenient raised position and because the end portions 7b of each rod or tubular element 7 are hidden in the cavity 4. Also the squashed portions of the end portions, at the region 8 thereof, are hidden in the cavity 4.

In addition, handles are very strong from two points of view: they are not subjected to tearing and their engagement with the bag is stable and reliable. In fact, due to said heatsealing the handles and bag substantially form a single body and in addition the region to be heatsealed can be extended at will. Said qualities of each tubular element 7 also enable only a single handle for each bag 2 to be arranged.

In fact, when provision is already made for means for closing mouth 3 upon itself, a single handle is sufficient for support of the bag and the absence of the other handle can be advantageous to facilitate filling of the bag 2, before closure of mouth 3.

The bag 2 having the above described support device 1 is accomplished by a process consisting in arranging at least one rod element of thermofusible plastic material, bending the rod element so that a bent intermediate portion is imposed on it as well as end portions positioned in the same manner with respect to each other, inserting the end portions into the bag mouth, and connecting the bag and end portions together by heatsealing.

In particular, the rod element is a semi-rigid tubular element bent in such a manner that concordant end directions or directions substantially parallel to each other are imposed on the end portions, i.e. positions that are bent in the same manner with respect to the intermediate portion.

By carrying out bending close to the bag mouth, bending itself gives rise to introduction of the end portions into the cavity of the bag. Bending can be facilitated by appropriate shaping elements and finally heatsealing is carried out from the outside of said bag, through localised squashing and heating operations.

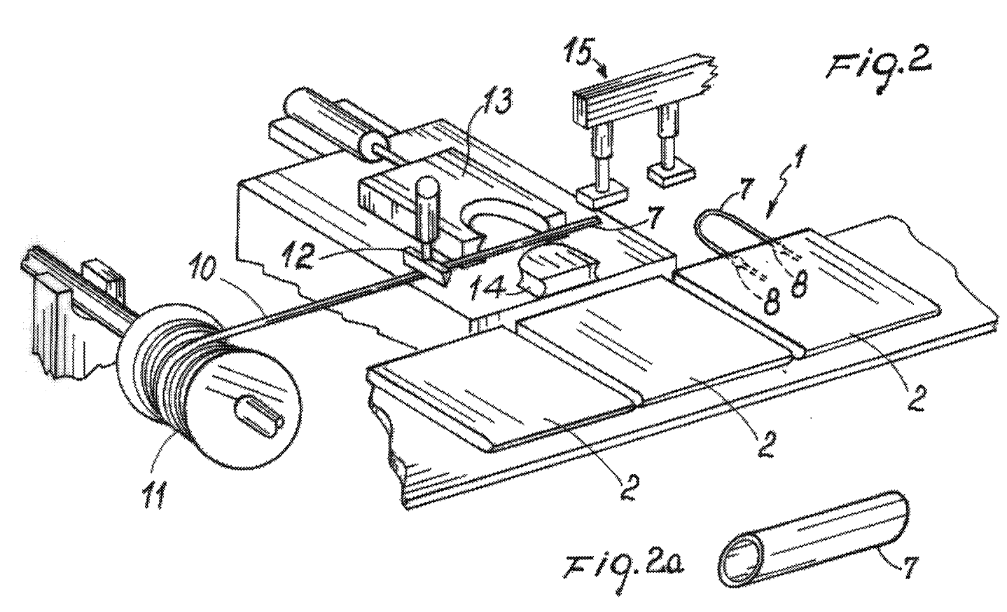

FIG. 2 generally shows a work station in which formation and application of each individual handle is carried out and it highlights how the whole process can be automated.

First of all a continuous tube 10 made of thermofusible plastic material, in particular Polythene or PVC or Polypropylene is fed from a reel 11 and it is then divided into sections by cutting members 12 for example, so as to make one tubular element 7 of predetermined sizes each time.

The tubular element 7 is obtained from the continuous small tube 10 in such a manner that it is immediately positioned—still with a straight arrangement—between a template 13 and a counter-template 14 having respective portions 13a and 14a facing each other and substantially arch-shaped.

The template 13 and counter-template 14 are selectively moved in such a manner that the tubular element 7 is given a conformation including one said intermediate rounded portion 7a and straight end portions 7b projecting from the template and counter-template and inserted in an adjacent bag 2.

Bag 2 can have any shape and structure and for introduction of the end portions 7b the respective mouth will be maintained conveniently open by suction cups, air jets, movable mechanical inserts or others. Preferably the end portions 7b are inserted into the adjacent bag 2 by mere bending of the tubular element 7.

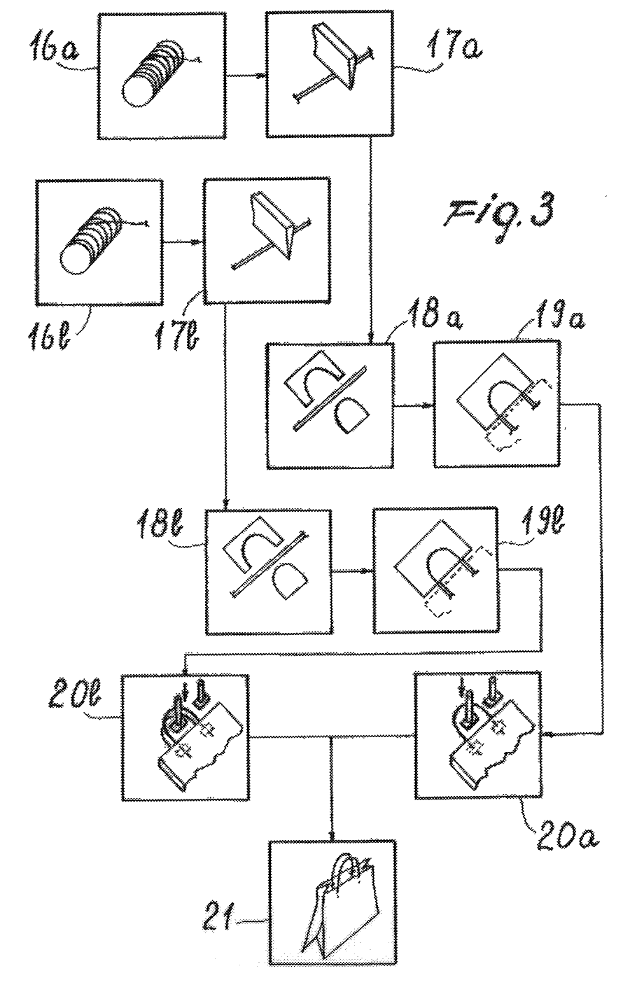

Finally, the end portions 7b and bag 2 are heatsealed with each other and heatsealing is carried out from the outside of the bag, by a heatsealing device 15. The different process steps are highlighted in the block diagram shown in FIG. 3. In said block diagram formation of a bag with two paired handles is shown. In particular, the first feeding step carried out by unrolling of the continuous small tube 10 is denoted at 16a and 16b whereas the subsequent step of cutting the continuous small tube into sections and forming the tubular elements 7 is denoted at 17a and 17b. In the subsequent steps 18a, 18b, 19a, 19b shaping of each tubular element 7 and partial introduction of same into an adjacent bag 2 is respectively carried out.

Finally, the handles are fastened by heatsealing at 20a, 20b and the completed bag is identified by 21.

This process is particularly advantageous: it enables accomplishment of a bag 2 with an improved support device 1 in a completely automated manner, and in addition it can be easily adapted for different aesthetic, practical or operational requirements. In fact tubular elements of varying thicknesses and lengths can be easily utilised without this fact substantially having any influence on the utilised structures.

For example, if the length of each applied tubular element is wished to be changed it is merely sufficiently to shift the cutting members.

In addition, a mere modification in the position of the bags relative to the template and counter-template gives rise to a different projection of the handles.

The template and counter-template are then substantially unaffected by the cross-sectional size of the tubular element and therefore a thickness variation can be always carried out.

The width and position of the heatsealed region can be also easily modified. Furthermore, the provided operations do not need great accuracy.

In fact, possible inaccuracies in the length and positioning of the tubular elements are unimportant because the template and counter-template and also the heatsealing operations are substantially unaffected by the length of said elements and their imprecise position. Then, possible length differences by excess or by defect are hidden by the bag, as well as possible inequalities in the measurements of the end portions of the handles.

The end portions inserted in bag 2 also conceal the cut regions and the qualitative level of the carried out cuttings. Inequalities in sealing are not visible as well. Therefore the apparatus putting the process into practice can be inexpensive and operate at high production rates.

1. Bag provided with an improved support device, said bag (2) having a support device (1), a mouth (3) extending close to said support device (1), a bottom (6) opposite to said mouth (3), and main walls (5a) and side walls (5b) extending between said mouth (3) and bottom (6), said support device (1) comprising at least one rod element (7) having at least one intermediate portion (7a) of a bent configuration and projecting from said mouth (3) and end portions (7b) inserted in said bag (2), said rod element (7) being of thermofusible plastic material, and said end portions (7b) being connected by heatsealing to at least one of said walls (5a, 5b).

2. Bag as claimed in claim 1, wherein said rod element (7) is a tubular element.

3. Bag as claimed in claim 1, wherein said rod element (7) is of a semi-rigid consistency, sai rod element (7) being of a plastic material selected among Polythene, PVC, Polypropylene.

4. Bag as claimed in claim 1, wherein two rod elements (7) are provided, each of them being heatsealed to a respective one of said main walls (5a).

5. Process for formation of a bag provided with an improved support device, said bag (2) having a support device (1), a mouth (3) extending close to said support device (1), a bottom (6) opposite to said mouth (3), and main walls (5a) and side walls (5b) extending between said mouth (3) and bottom (6), said process consisting in: arranging at least one rod element (7) of thermofusible plastic material, bending said rod element (7) so that a bent intermediate portion (7a) is imposed on it as well as end portions (7b) positioned in the same manner with respect to each other, inserting said end portions into said mouth (3) of said bag (2) and connecting said bag (2) and end portions (7b) to each other by heatsealing.

6. Process as claimed in claim 5, wherein said rod element (7) is of semi-rigid consistency and it is such bent that directions substantially parallel to each other are imposed on said end portions (7b).

7. Process as claimed in claim 5, wherein said end portions (7b) are inserted into said bag (2) by bending of said rod element (7) carried out close to said mouth (3).

8. Process as claimed in claim 5, wherein said heatsealing is carried out from the outside of said bag (2), by localised squashing and heating operations.

9. Process as claimed in claim 5, wherein said rod element (7) is bent by inserting it between a template (13) and a counter-template (14) and selectively moving said template (13) and counter-template (14) so that said rod element (7) is given a conformation including said bent intermediate portion (7a) and said end portions (7b) projecting from said template (13) and counter-template (14), for insertion of same into an adjacent bag (2).

10. Process as claimed in claim 5, wherein each said rod element (7) is obtained by dividing into sections a continuous tube (10) wound on a reel and fed therefrom.
